(19) United States
(12) Patent Application Publication
(10) Pub. No.: US 2026/0337498 A1
(43) Pub. Date: Oct. 29, 2026

(54) SYSTEMS AND METHODS FOR REMOVAL OF SILICON COMPOUNDS FROM PYROLYSIS OIL BY INERT GAS TREATMENT

(71) Applicant: SABIC Global Technologies B.V., Bergen OP Zoom (NL)

(72) Inventors: Safa FARAJZADEH, Geleen (NL); Fabrice CUOQ, Geleen (NL); Kae WONG, Geleen (NL)

(21) Appl. No.: 19/485,920

(22) PCT Filed: May 15, 2024
(86) PCT No.: PCT/IB2024/054732

§ 371 Date: Nov. 19, 2025

Related U.S. Application Data
(60) Provisional application No. 63/503,240, filed on May 19, 2023.

(51) Int. Cl. C10G 29/02; B01D 3/34; B01D 8/00; B01D 11/04; C10G 5/06; C10G 31/08

(52) U.S. Cl. CPC C10G 29/02; B01D 3/346; B01D 8/00; B01D 11/0446; C10G 5/06; C10G 31/08; C10G 2300/1003; C10G 2300/202

(57) ABSTRACT

Provided here are methods and systems for converting pyrolysis oil with silicon-based compounds to a substantially silicon-free pyrolysis oil by treatment with an inert gas. A method of treating a pyrolysis oil to remove silicon-based compounds includes supplying an inert gas stream to a storage vessel containing a pyrolysis oil with silicon-based compounds to produce a silicon-enriched inert gas stream and a desiliconized pyrolysis oil containing at least five weight percent less of the silicon-based compounds as compared to the pyrolysis oil. The method also includes supplying the silicon-enriched inert gas stream to a cryogenic unit to recover hydrocarbons or the silicon-based compounds from the silicon-enriched inert gas stream.

### TECHNICAL FIELD

The present disclosure generally relates to systems and methods for removing silicon compounds from pyrolysis oil. More specifically, the present disclosure relates to systems and methods for removing silicon compounds from pyrolysis oil in a vessel by passing an inert gas stream through the vessel headspace or by bubbling the inert gas stream through the pyrolysis oil.

### BACKGROUND

Mixed plastic waste (MPW) is an opportunity feed that can be used to make hydrocarbonaceous products, like pyrolysis oil or synthetic crude oil. The mixed plastic waste is depolymerized to yield this liquid product, which can be processed by crackers and other refinery units. This chemical recycling route provides innovative paths to produce circular or cyclic polymer economies. Although MPW is mainly composed of polyolefins, there are residues of non-polyolefins and plastics additives that may end up in the pyoil and lead to undesired compounds, which are detrimental to downstream units, such as a steam cracker or a refinery. These undesired residues contain heteroatoms, such as chlorine, nitrogen, oxygen, and silicon. To transform pyoil into a suitable feedstock for downstream units, substantially all of these non-hydrocarbon compounds need to be removed. These non-hydrocarbon compounds include silicon-containing compounds. Silicon exists abundantly in pyoil samples, ranging from about 5 parts per million (ppm) to 500 ppm. Presence of silicon in steam cracker feedstock leads to fouling, corrosion, and catalyst deactivation.

### SUMMARY

Having recognized a need to remove at least one of the aforementioned silicon-based compounds from the pyoil, Applicant developed systems and processes described herein. In some embodiments, these systems and processes result in pyoil compositions containing less than 5 ppm of silicon, or less than 1 ppm, or even less than 0.5 ppm. In certain embodiments, the method of treating pyrolysis oil to remove silicon-based compounds includes the steps of supplying an inert gas stream to a storage vessel containing a pyrolysis oil with silicon-based compounds to produce a silicon-enriched inert gas stream and a desiliconized pyrolysis oil containing at least ten weight percent less of the silicon-based compounds as compared to the pyrolysis oil, and conveying the silicon-enriched inert gas stream to a cold trap to capture the silicon-based compounds from the silicon-enriched inert gas stream. The pyrolysis oil is treated with the inert gas in the absence of any catalyst in the storage vessel. The cold trap can include liquid nitrogen or other freezing mixture, such as dry ice in acetone or a similar solvent with a low melting point.

In certain embodiments, the desiliconized pyrolysis oil and water are supplied to a reactor equipped with a mixing element. After mixing, a silicon-enriched water stream is separated from the mixture to produce a substantially silicon-free pyrolysis oil.

In certain embodiments, the storage vessel is maintained at ambient temperature. In certain embodiments, the inert gas stream contains nitrogen, argon, helium, or combinations thereof. In certain embodiments, the inert gas stream is supplied to a headspace above the pyrolysis oil or bubbled through the pyrolysis oil in the storage vessel.

Embodiments also include systems of treating pyrolysis oil to remove silicon-based compounds. One such system includes a storage vessel containing a pyrolysis oil with silicon-based compounds and equipped with a first inlet for receiving an inert gas stream and a first outlet for discharging a silicon-enriched inert gas stream. In certain embodiments, the storage vessel is maintained at ambient temperature. The inert gas stream contains one or more of nitrogen, argon, helium, or combinations thereof. The first inlet can be positioned in the storage vessel to receive the inert gas at a headspace above the pyrolysis oil in the storage vessel, or the first inlet can be positioned proximal to the floor of the storage vessel to pass the inert gas through the pyrolysis oil in the storage vessel. This first outlet is connected to and in fluid communication with a second inlet of a cold trap. The silicon-enriched inert gas stream is produced along with a desiliconized pyrolysis oil from interactions between the inert gas stream and the pyrolysis oil. The desiliconized pyrolysis oil contains at least five weight percent less of the silicon-based compounds as compared to the pyrolysis oil. In some embodiments, the desiliconized pyrolysis oil contains at least ten weight percent less of the silicon-based compounds as compared to the pyrolysis oil. The system further includes the cold trap equipped with the second inlet connected to and in fluid communication with the first outlet of the storage vessel to receive the silicon-enriched inert gas stream and designed to condense and reclaim a portion of the hydrocarbon vapors or the silicon-based compounds. In certain embodiments, the system can include one or more of pressurized inert gas storage tanks, bubblers to manage the pressure before supplying the inert gas to the storage vessel, and flow meters to manage the flow of the inert gas to the storage vessel.

Certain embodiments of the system also include the storage vessel with a second outlet in fluid communication with a third inlet of a reactor. The reactor also includes a fourth inlet to receive a water stream, a mixing element to mix the desiliconized pyrolysis oil and the water, and a third outlet connected to and in fluid communication with a fifth inlet of a separator. The system further includes the separator equipped with the fifth inlet that is connected to and in fluid communication with the third outlet to receive the mixture of the desiliconized pyrolysis oil and water. In certain embodiments, the separator is operated to separate a silicon-enriched water stream and a substantially silicon-free pyrolysis oil that contains at least ten weight percent less of the silicon-based compounds as compared to the desiliconized pyrolysis oil.

In certain embodiments, the system includes a water treatment unit equipped with a sixth inlet connected to and in fluid communication with a fourth outlet of the separator. This water treatment unit is operated to remove the silicon-based compounds from the silicon-enriched water stream and produce a substantially silicon-free water stream. In certain embodiments, the water treatment unit is equipped with a fifth outlet that is connected to and in fluid communication with the seventh outlet of the reactor to recycle the substantially silicon-free water stream.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a diagrammatic representation of a method of treating pyrolysis oil to remove silicon-based compounds by supplying an inert gas stream to pyrolysis oil in a storage vessel, followed by water treatment of the pyrolysis oil in a reactor to produce a substantially silicon-free pyrolysis oil.

FIG. 2 is a diagrammatic representation of a system to treat pyrolysis oil containing silicon-based compounds, which includes a storage vessel, a cold trap, a reactor, and a separator to produce a substantially silicon-free pyrolysis oil.

### DETAILED DESCRIPTION

The present disclosure describes various embodiments related to processes, devices, and systems for reducing the amount of silicon-based compounds in a pyrolysis oil to produce a desiliconized pyrolysis oil. More specifically, the present disclosure relates to systems and methods for converting pyrolysis oil with silicon-based compounds to a desiliconized pyrolysis oil that is usable for a cracking unit or other refinery unit. Further embodiments may be described and disclosed. In the following description, numerous details are set forth in order to provide a thorough understanding of the various embodiments. In other instances, well-known processes, devices, and systems may not have been described in particular detail in order not to unnecessarily obscure the various embodiments. Additionally, illustrations of the various embodiments may omit certain features or details in order to not obscure the various embodiments.

The description may use the phrases “in certain embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous. The term “about” is defined as being close to as understood by one of ordinary skill in the art. In one non-limiting embodiment, the terms are defined to be within 10%, preferably within 5%, more preferably within 1%, and most preferably within 0.5%.

The terms “removing,” “removed,” “reducing,” “reduced,” or any variation thereof, when used in the claims and/or the specification includes any measurable decrease of one or more components in a mixture to achieve a desired result. The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.” The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component. In certain embodiments, when a composition is substantially free of a particular component, the composition contains less than 5 ppm, 4 ppm, 3 ppm, 2 ppm, or 1 ppm of that component. In certain embodiments, when a composition is substantially free of a particular component, the composition contains less than 0.9 ppm, 0.8 ppm, 0.7 ppm, 0.6 ppm, or 0.5 ppm of that component.

Embodiments include methods of treating pyrolysis oil to remove silicon-based compounds. Silicon-based compounds present in pyoil include siloxanes, which are compounds with a backbone of two or more —SiO— groups. The siloxane compounds can be branched or unbranched, and linear or cyclic. Silicon-based compounds in pyoil from pyrolysis of plastic additive or silicone rubber are mainly cyclic siloxanes, such as hexamethylcyclotrisiloxane, octamethylcyclotetrasiloxane, and decamethylcyclopentasiloxane. In certain embodiments, the desiliconized pyrolysis oil contains about less than 200 ppm, 180 ppm, 150 ppm, 100 ppm, 50 ppm, or 10 ppm of cyclic siloxanes. In certain embodiments, the desiliconized pyrolysis oil contains about less than 180 ppm, 160 ppm, 130 ppm, 80 ppm, 40 ppm, or 8 ppm of hexamethylcyclotrisiloxane.

Embodiments of the methods include supplying an inert gas stream to a storage vessel containing a pyrolysis oil with silicon-based compounds to produce a silicon-enriched inert gas stream and a desiliconized pyrolysis oil. The pyrolysis oil is treated with the inert gas in the absence of any catalyst in the storage vessel. The removal of silicon-based compounds by passing the inert gas through the pyrolysis oil is driven by the gas flow rate, duration of gas flow, volatility of the silicon-based compounds, and the extent of the gas-liquid interface. In certain embodiments, the introduction of inert gas to the pyrolysis oil can be in the form of finely dispersed gas bubbles with a high gas-liquid interface by passing the gas through sparging equipment, such as nozzles, rings, heads, pipes, porous sparger elements, or any combinations thereof. In certain embodiments, the inert gas is passed through the headspace above the pyrolysis oil to sweep the silicon-based compounds from the storage vessel. In certain embodiments, at least five weight percent of the silicon-based compounds present in the pyrolysis oil are removed. In certain embodiments, at least ten weight percent of the silicon-based compounds present in the pyrolysis oil are removed. In certain embodiments, at least fifteen weight percent of the silicon-based compounds present in the pyrolysis oil are removed. In certain embodiments, at least twenty weight percent of the silicon-based compounds present in the pyrolysis oil are removed. In certain embodiments, the storage vessel is maintained at ambient temperature. In certain embodiments, at least five weight percent of the cyclic siloxanes present in the pyrolysis oil are removed. In certain embodiments, at least ten weight percent of the cyclic siloxanes present in the pyrolysis oil are removed. In certain embodiments, at least fifteen weight percent of the cyclic siloxanes present in the pyrolysis oil are removed. In certain embodiments, at least twenty weight percent of the cyclic siloxanes present in the pyrolysis oil are removed. In certain embodiments, at least ten weight percent of hexamethylcyclotrisiloxane present in the pyrolysis oil is removed. In certain embodiments, at least fifteen weight percent of hexamethylcyclotrisiloxane present in the pyrolysis oil is removed. In certain embodiments, at least sixteen weight percent, seventeen weight percent, eighteen weight percent, or nineteen weight percent of hexamethylcyclotrisiloxane present in the pyrolysis oil is removed. In certain embodiments, at least twenty weight percent of hexamethylcyclotrisiloxane present in the pyrolysis oil is removed.

In certain embodiments, the inert gas stream contains nitrogen, argon, helium, or combinations thereof. In certain embodiments, the gas flow rate ranges from 1 to 5 liters per minute. In certain embodiments, the gas flow rate ranges from 0.05 to 3 liters per minute. In certain embodiments, the gas flow rate ranges from 0.10 to 1.5 liters per minute. The gas flow rate is dependent on the amount to pyrolysis oil in the vessel and the dimensions and design of the storage vessel. In certain embodiments, the amount of nitrogen purged is about 10 liters per square meter (L/m²) to about 400 L/m². In certain embodiments, the inert gas stream is allowed to interact with silicon-based compounds of the pyrolysis oil from about 1 hour to about 5 hours. In certain embodiments, the inert gas stream is allowed to interact with silicon-based compounds of the pyrolysis oil from about 2 hours to about 4 hours.

The method can further include conveying the desiliconized pyrolysis oil, along with water, to a reactor equipped with a mixing element. In some embodiments, instead of water, the desiliconized pyrolysis oil can be treated with an aqueous alkaline solution. The desiliconized pyrolysis oil and water are mixed to produce a silicon-enriched water stream and a substantially silicon-free pyrolysis oil. In certain embodiments, at least five weight percent of the silicon-based compounds present in the desiliconized pyrolysis oil are removed. In certain embodiments, at least ten weight percent of the silicon-based compounds present in the desiliconized pyrolysis oil are removed. In certain embodiments, at least twenty fifteen percent of the silicon-based compounds present in the pyrolysis oil are removed. In certain embodiments, the mixing element is one or more of an agitator, an impeller, a baffle, or a draft tube configured within the reactor to provide effective mixing of the desiliconized pyrolysis oil and water. In certain embodiments, the impeller is one of three types such as a propeller, paddle, or turbine, which generate either axial or radial flow of the fluids within the reactor. In certain embodiments, the silicon-enriched water stream is separated from the desiliconized pyrolysis oil in a separator to produce a substantially silicon-free pyrolysis oil. In certain embodiments, the phase separated silicon-enriched water phase and the substantially silicon-free pyoil phase can be selectively removed from the reactor. In certain embodiments, the separator can be vertically or horizontally arranged to separate two or three phases. In certain embodiments, the separator can use momentum, gravity settling, or coalescing mechanisms for separating the silicon-enriched water phase and the substantially silicon-free pyoil phase.

In certain embodiments, the method further includes supplying the silicon-enriched water stream from the separator or reactor to a water treatment unit to remove the silicon-based compounds. The substantially silicon-free water can be recycled to the reactor.

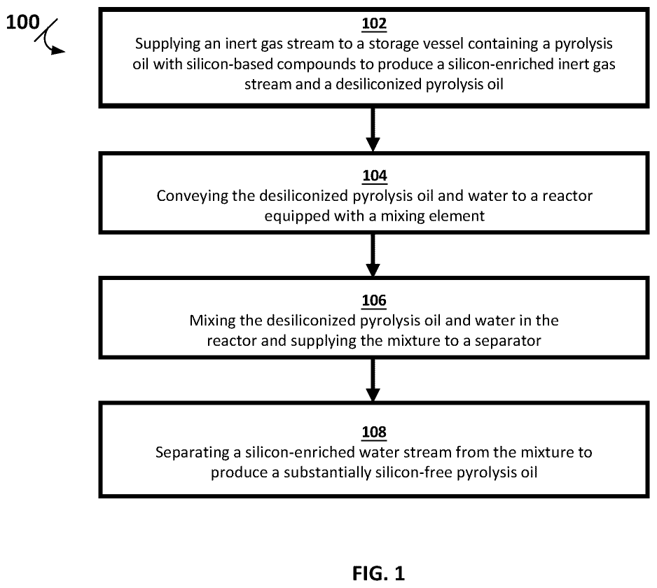

FIG. 1 is a diagrammatic representation of a method 100 of treating pyrolysis oil to remove silicon-based compounds by supplying an inert gas stream to pyrolysis oil containing silicon-based compounds in a storage vessel, followed by water treatment of the desiliconized pyrolysis oil in a reactor to produce a substantially silicon-free pyrolysis oil. This method 100 includes a step 102 of supplying an inert gas stream to a storage vessel containing a pyrolysis oil with silicon-based compounds to produce a silicon-enriched inert gas stream and a desiliconized pyrolysis oil. The desiliconized pyrolysis oil contains at least five weight percent less of the silicon-based compounds as compared to the unstripped pyrolysis oil. The desiliconized pyrolysis oil contains at least ten weight percent less of the silicon-based compounds as compared to the unstripped pyrolysis oil. In an embodiment, the storage vessel is maintained at ambient temperature. In an embodiment, the inert gas stream contains nitrogen, argon, helium, or combinations thereof. In certain embodiments, the inert gas is supplied to a headspace above the pyrolysis oil in the storage vessel. In certain embodiments, the inert gas is bubbled through the pyrolysis oil in the storage vessel. In certain embodiments, the method further includes the step of conveying the silicon-enriched inert gas stream to a cryogenic unit to condense or reclaim a portion of the hydrocarbon vapors or the silicon-based compounds. The cryogenic unit can be one or more cold traps. The cryogenic unit may be a cold trap utilizing liquid nitrogen as a chilling medium. In certain embodiments, the recovered hydrocarbons from the cryogenic unit are recycled to the storage vessel containing the pyrolysis oil.

The method contains a further step 104 of conveying the desiliconized pyrolysis oil and water to a reactor equipped with a mixing element. The desiliconized pyrolysis oil and water are mixed in the reactor to produce a substantially silicon-free pyrolysis oil. In certain embodiments, the mixture of the desiliconized pyrolysis oil and water from the reactor in step 106 is supplied to a separator. The method contains a further step 108 of separating the silicon-enriched water stream from the mixture to produce a substantially silicon-free pyrolysis oil.

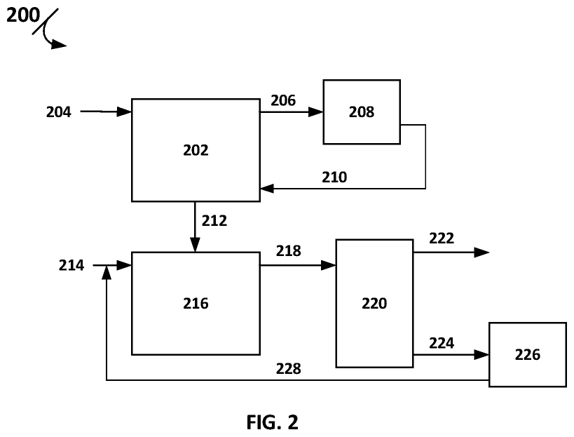

Embodiments also include systems of treating pyrolysis oil to remove silicon-based compounds. FIG. 2 is a diagrammatic representation of a system 200 to treat a pyrolysis oil that contains silicon-based compounds. This system 200 includes a vessel 202 containing a pyrolysis oil with silicon-based compounds and equipped with a first inlet for receiving an inert gas stream 204 and a first outlet for discharging a silicon-enriched inert gas stream 206. In certain embodiments, the storage vessel 202 is maintained at ambient temperature. The inert gas stream 204 contains one or more of nitrogen, argon, helium, or combinations thereof. The first inlet can be positioned in the storage vessel 202 to receive the inert gas at a headspace above the pyrolysis oil in the storage vessel 202, or the first inlet can be positioned proximal to the floor of the storage vessel 202 to pass the inert gas through the pyrolysis oil in the storage vessel. This first outlet is connected to and in fluid communication with a second inlet of a cold trap 208. In certain embodiments, the cold trap utilizes liquid nitrogen as a chilling medium. Other cryogenic units may be utilized instead of a cold trap. The silicon-enriched inert gas stream 206 is produced along with a desiliconized pyrolysis oil 212 from interactions between the inert gas stream and the pyrolysis oil. The desiliconized pyrolysis oil 212 contains at least ten weight percent less of the silicon-based compounds as compared to the pyrolysis oil. In certain embodiments, the storage vessel 202 is maintained at ambient temperature. In certain embodiments, the system can include one or more of pressurized inert gas storage tanks, bubblers to manage the pressure before supplying the inert gas to the storage vessel, and flow meters to manage the flow of the inert gas to the storage vessel.

The system further includes the cold trap 208 equipped with the second inlet connected to and in fluid communication with the first outlet of the storage vessel 202 to receive the silicon-enriched inert gas stream 206 and designed to condense and reclaim a portion of the hydrocarbon vapors that may be recycled to the storage vessel 202 as recycle stream 210.

Certain embodiments of the system also include the storage vessel 202 with a second outlet in fluid communication with a third inlet of a reactor 216. The reactor 216 also includes a fourth inlet to receive a water stream 214, a mixing element to mix the desiliconized pyrolysis oil and the water, and a third outlet connected to and in fluid communication with a fifth inlet of a separator 220. The system 200 further includes the separator 220 equipped with the fifth inlet that is connected to and in fluid communication with the third outlet to receive the mixture 218 of the desiliconized pyrolysis oil and water. In certain embodiments, the separator 220 is operated to separate a silicon-enriched water stream 224 and a substantially silicon-free pyrolysis oil 222 that contains at least twenty weight percent less of the silicon-based compounds as compared to the desiliconized pyrolysis oil.

In certain embodiments, the system 200 includes a water treatment unit 226 equipped with a sixth inlet connected to and in fluid communication with a fourth outlet of the separator 220. This water treatment unit 226 is operated to remove the silicon-based compounds from the silicon-enriched water stream and produce a substantially silicon-free water stream 228. In certain embodiments, the water treatment unit is equipped with a fifth outlet that is connected to and in fluid communication with the seventh outlet of the reactor to recycle the substantially silicon-free water stream 228.

### EXAMPLES

Pyrolysis oil was subjected to a flow of nitrogen to remove silicon-based compounds. A sample of pyrolysis oil was placed in a vessel equipped with a gas line capable of a range of nitrogen flow rates of between zero and two liters per minute (LPM). The vessel was sparged with a flow of nitrogen, with components collected by the sparge gas being condensed in a cold trap and collected for analysis. The purge of nitrogen was maintained for three hours. The testing vessel was sealed after the two-hour period and analyzed for silicon content. The results are shown in Error! Reference source not found. It shows clearly that the amount of hexamethylcyclotrisiloxane (D3) is decreased by about 20% via the nitrogen purging.

TABLE 1
Results of Nitrogen Treatment

| | | Pyoil after N₂ purge |
|---|---|---|
| | Pyoil before N₂ purge | 3 h @ 20 °C |
| | Si content [ppm] | Si content [ppm] |
| Total Si in form of D3 | 98 | 79 |
| Total Si Content | 183 | 166 |

Other objects, features and advantages of the disclosure will become apparent from the foregoing figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from the detailed description. In further embodiments, features from specific embodiments may be combined with features from other embodiments. For example, features from one embodiment may be combined with features from any of the other embodiments. In further embodiments, additional features may be added to the specific embodiments described herein.

What is claimed is:

1. A method of treating pyrolysis oil to remove silicon-based compounds, the method comprising:
supplying an inert gas stream to a storage vessel containing the pyrolysis oil with the silicon-based compounds to produce a silicon-enriched inert gas stream and a desiliconized pyrolysis oil containing at least five weight percent less of the silicon-based compounds as compared to the pyrolysis oil; and
supplying the silicon-enriched inert gas stream to a cryogenic unit to recover hydrocarbons or the silicon-based compounds from the silicon-enriched inert gas stream.

2. The method of claim 1, wherein the cryogenic unit is a cold trap utilizing liquid nitrogen as a chilling medium.

3. The method of claim 1, further comprising:
conveying the desiliconized pyrolysis oil and water to a reactor equipped with a mixing element to produce a mixture of the desiliconized pyrolysis oil and water and supplying the mixture to a separator; and
separating a silicon-enriched water stream from the mixture to produce a substantially silicon-free pyrolysis oil containing at least ten weight percent less of the silicon-based compounds as compared to the desiliconized pyrolysis oil.

4. The method of claim 3, further comprising the steps of:
supplying the silicon-enriched water stream to a water treatment unit to remove the silicon-based compounds and produce a substantially silicon-free water stream; and
recycling the substantially silicon-free water stream to the reactor.

5. The method of claim 1, wherein the inert gas stream contains nitrogen, argon, helium, or combinations thereof.

6. The method of claim 1, wherein the inert gas stream is a nitrogen gas stream supplied to a headspace above the pyrolysis oil in the storage vessel.

7. The method of claim 1, wherein the inert gas stream is a nitrogen gas stream bubbled through the pyrolysis oil in the storage vessel.

8. The method of claim 1, wherein the desiliconized pyrolysis oil contains at least five weight percent less of cyclic siloxanes as compared to the pyrolysis oil.

9. The method of claim 1, wherein the desiliconized pyrolysis oil contains at least ten weight percent less of hexamethylcyclotrisiloxane as compared to the pyrolysis oil.

10. The method of claim 1, wherein the desiliconized pyrolysis oil contains at least fifteen weight percent less of hexamethylcyclotrisiloxane as compared to the pyrolysis oil.

11. A system for treating pyrolysis oil to remove silicon-based compounds, the system comprising:
a storage vessel containing the pyrolysis oil with the silicon-based compounds and equipped with a first inlet for receiving an inert gas stream and a first outlet connected to and in fluid communication with a second inlet of a cryogenic unit, a silicon-enriched inert gas stream being produced along with a desiliconized pyrolysis oil from interactions between the inert gas stream and the pyrolysis oil, and the desiliconized pyrolysis oil containing at least five weight percent less of the silicon-based compounds as compared to the pyrolysis oil; and
the cryogenic unit equipped with the second inlet to receive the silicon-enriched inert gas stream from the first outlet and designed to condense and reclaim a portion of hydrocarbon vapors or the silicon-based compounds from the silicon-enriched inert gas stream.

12. The system of claim 11, further comprising;
the storage vessel equipped with a second outlet connected to and in fluid communication with a third inlet of a reactor;
the reactor equipped with the third inlet to receive the desiliconized pyrolysis oil, a fourth inlet to receive water, a mixing element to mix the desiliconized pyrolysis oil and the water, and a third outlet connected to and in fluid communication with a fifth inlet of a separator; and
the separator equipped with the fifth inlet to receive a mixture of the desiliconized pyrolysis oil and the water from the third outlet, the separator being operated to separate the mixture to produce a silicon-enriched water stream and a substantially silicon-free pyrolysis oil containing at least ten weight percent less of the silicon-based compounds as compared to the desiliconized pyrolysis oil.

13. The system of claim 11, wherein the storage vessel is maintained at ambient temperature.

14. The system of claim 11, wherein the inert gas stream contains nitrogen, argon, helium, or combinations thereof.

15. The system of claim 11, wherein the first inlet is positioned in the storage vessel to receive the inert gas stream at a headspace above the pyrolysis oil in the storage vessel.

16. The system of claim 11, wherein the first inlet is positioned proximal to a floor of the storage vessel to pass the inert gas stream through the pyrolysis oil in the storage vessel.

17. The system of claim 12, further comprising:
the separator equipped with a fourth outlet connected to and in fluid communication with a sixth inlet of a water treatment unit; and
the water treatment unit with the sixth inlet to receive the silicon-enriched water stream from the fourth outlet, the water treatment unit being operated to remove the silicon-based compounds from the silicon-enriched water stream and produce a substantially silicon-free water stream.

18. The system of claim 17, wherein the water treatment unit has a fifth outlet connected to and in fluid communication with a seventh inlet of the reactor to receive the substantially silicon-free water stream into the reactor.

19. The system of claim 11, wherein the desiliconized pyrolysis oil contains at least five weight percent less of cyclic siloxanes as compared to the pyrolysis oil.

20. The system of claim 11, wherein the desiliconized pyrolysis oil contains at least fifteen weight percent less of hexamethylcyclotrisiloxane as compared to the pyrolysis oil.
